(19) United States
(12) Patent Application Publication
(10) Pub. No.: US 2025/0145376 A1
(43) Pub. Date: May 8, 2025

(54) STORAGE AND RETRIEVAL SYSTEM

(71) Applicant: OCADO INNOVATION LIMITED, Hatfiled, Hertfordshire (GB)

(72) Inventor: Tim STEINER, Hatfield, Herfordshire (GB)

(21) Appl. No.: 18/832,255

(22) PCT Filed: Jan. 23, 2023
(86) PCT No.: PCT/US2023/011331

§ 371 Date: Jul. 23, 2024

(30) Foreign Application Priority Data
Jan. 25, 2022 (GB) 2200940.1

(51) Int. Cl. B65G 1/137; B65G 1/04; G06Q 10/08

(52) U.S. Cl. CPC B65G 1/1373; B65G 1/0464; G06Q 10/08

(57) ABSTRACT

The present disclosure provides a storage and retrieval system which can be operated to efficiently deliver goods, for example groceries, using two different methods. Capacity within one or more delivery vehicles may be assigned to orders placed in advance for later delivery and also for rapid orders for quick delivery.

### RELATED APPLICATIONS

This application claims priority to U.K. Provisional Application No. 2200940.1 filed on Jan. 25, 2022; the disclosure of which is hereby incorporated by reference in its entirety.

### BACKGROUND

The disclosure relates to methods for efficiently retrieving items from an automatic storage and retrieval system and delivering them to a delivery location.

Typically, customers of online grocery delivery services select a date and a timeslot for their delivery. Typically the date of the delivery will be from the next day to within a few weeks from the date that the order is placed. The customer selects the items that they wish to have delivered and saves the order. It is possible for the customer to subsequently update their order, for example by adding in further items or deleting items from the existing order, until a cut-off time. Typically, this cut-off time occurs on the day before the date of the delivery. Once the cut-off time has passed then the orders for the next day can no longer be altered and it is possible for the orders to be assigned to delivery vehicles such that the routes of the delivery vehicles can be optimised, for example to reduce travel times, to minimise the number of vehicles required to deliver all of the orders, to vehicle emissions, etc. The orders can then be picked, the delivery containers loaded onto the appropriate delivery vehicle and then the vehicles can deliver the ordered goods in the requested timeslot. The fulfilment centres that are typically used for such advance delivery services can offer a wide range of products similar to that found in a supermarket, for example 30,000 SKUs (Stock Keeping Units) or greater. Typically, an advanced delivery order is equivalent to a trip to a supermarket for a weekly shopping trip.

An alternative form of customer delivery is often referred to as a rapid delivery service. In such a case, a customer will select a time slot, which is typically later on the same day, or will choose to have the order delivered as soon as possible. The customer will then select the items that they wish to have delivered and complete the order. There is no opportunity for the customer to subsequently update their order. Once placed, the order will be picked and then delivered in the appropriate timeslot. Typically, the order will be picked manually in a dark store, which carries a similar range of goods which can be found in a conventional convenience shop, for example around 1000 SKUs. Typically, a rapid delivery order is equivalent to a trip to a local store for the ingredients for a meal.

Once picked, the order is delivered in the selected timeslot. Typically a rapid delivery will deliver a single order, although it is possible for orders that are geographically close together and that have similar timeslots to be delivered together.

### SUMMARY

According to a first aspect of the present disclosure, there is provided a method of assigning delivery orders to one or a plurality of delivery vehicles, the method comprising the steps of: for each of the plurality of vehicles, allocating a first portion of the vehicle load capacity for use with a first reservation method; and allocating a second portion of the vehicle load capacity for use with a second reservation method. Requests which are made according to the first reservation method may be processed until a first cut-off time. After the first cut-off time the remaining vehicle load capacity allocated for use with the first reservation method may be re-allocated for use with the second reservation method. The route of one or more delivery vehicles may be optimised after one or more requests made according to the first reservation method have been processed.

This enables a single fulfilment centre to be able to supply goods to customers using both advanced and rapid order delivery services. This reduces the need for rapid order delivery services facilities to be provided. Furthermore, the range of goods which can be provided using rapid order delivery services is significantly expanded. By adding a rapid delivery into an optimised delivery route, the environmental impact of making the delivery is reduced.

Requests made according to the second reservation method may be processed until a second cut-off time. The route of one or more delivery vehicles may be optimised after the second cut-off time. The optimisation of a delivery route may be based on the requests made according to the second reservation method for the associated delivery vehicle. A delivery route may be optimised such that the deliveries associated with the requests made according to the second reservation method are made during the outward portion of the delivery route.

The orders associated with the requests made according to the first reservation method may be picked after the first cut-off time. In particular, the orders associated with the requests made according to the first reservation method may be picked before the second cut-off time. Orders associated with the requests made according to the second reservation method may be picked after the second cut-off time. The orders associated with a delivery vehicle may be loaded onto the delivery vehicle.

According to a second aspect of the present disclosure there is provided an apparatus for determining the loading of each of a plurality of vehicles, the apparatus comprising one or more processors and one or more data storage units, the apparatus being configured, in use, to perform a method as described above.

According to a third aspect of the present disclosure there is provided a storage system comprising: a first set of parallel tracks extending in an X-direction, and a second set of parallel tracks extending in a Y-direction transverse to the first set in a substantially horizontal plane to form a grid pattern comprising a plurality of grid spaces; a plurality of stacks of storage containers located beneath the tracks, and arranged such that each stack is located within a footprint of a single grid space; at least one transporting device, the at least one transporting device being arranged to selectively move in the X and/or Y directions, above the stacks on the tracks and arranged to transport a storage container; a picking station arranged to receive a storage container transported by the at least one transporting device and to transfer an item from the storage container into a delivery container; and wherein the storage system is configured to perform a method as described above. The at least one transporting device may have a footprint that occupies only a single grid space in the storage system, such that a transporting device occupying one grid space does not obstruct a transporting device occupying or traversing the adjacent grid spaces in the X and/or Y directions.

According to yet another aspect of the present disclosure there is provided a method of assigning delivery orders to one or a plurality of delivery vehicles. The method can include: for each of the plurality of vehicles, allocating a first portion of the vehicle load capacity for use with a first reservation method; and allocating a second portion of the vehicle load capacity for use with a second reservation method.

The method of the preceding paragraph can include one or more of the following features: Requests made according to the first reservation method can be processed until a first cut-off time. After the first cut-off time the remaining vehicle load capacity allocated for use with the first reservation method can be re-allocated for use with the second reservation method. The route of one or more delivery vehicles can be optimised after one or more requests made according to the first reservation method have been processed. Requests made according to the second reservation method can be processed until a second cut-off time. The route of one or more delivery vehicles can be optimised after the second cut-off time. The optimisation of a delivery route can be based on the requests made according to the second reservation method for the associated delivery vehicle. The delivery route can be optimised such that the deliveries associated with the requests made according to the second reservation method are made during the outward portion of the delivery route. The orders associated with the requests made according to the first reservation method can be picked after the first cut-off time. The orders associated with the requests made according to the first reservation method can be picked before the second cut-off time. The orders associated with the requests made according to the second reservation method can be picked after the second cut-off time. The orders associated with a delivery vehicle can be loaded onto the delivery vehicle.

According to a further aspect of the present disclosure there is provided an apparatus for determining the loading of each of a plurality of vehicles. The apparatus can include one or more processors and one or more data storage units. The apparatus can be configured, in use, to perform the method of any of the preceding two paragraphs. Additionally, according to yet a further aspect of the present disclosure there is provided a storage system. The storage system can include a first set of parallel tracks, a second set of parallel tracks, a plurality of stacks of storage containers, at least one transporting device, and a picking station. The first set can extend in an X-direction, and the second set can extend in a Y-direction transverse to the first set in a substantially horizontal plane to form a grid pattern comprising a plurality of grid spaces. The plurality of stacks of storage containers can be located beneath the tracks, and arranged such that each stack is located within a footprint of a single grid space. The at least one transporting device can be arranged to selectively move in the X and/or Y directions, above the stacks on the tracks and arranged to transport a storage container. The picking station can be arranged to receive a storage container transported by the at least one transporting device and to transfer an item from the storage container into a delivery container. The storage system can be configured to perform the method of any of the preceding two paragraphs. The at least one transporting device can have a footprint that occupies only a single grid space in the storage system, such that a transporting device occupying one grid space does not obstruct a transporting device occupying or traversing the adjacent grid spaces in the X and/or Y directions.

According to another aspect of the present disclosure there is provided a method of managing delivery orders. The method can include, for each of a plurality of delivery vehicles: allocating, by one or more hardware processors, a first portion of a vehicle load capacity for filling by a first reservation method; and allocating, by the one or more hardware processors, a second portion of the vehicle load capacity for filling by a second reservation method.

The method of the preceding paragraph can include one or more of the following features: The method can further include processing, by the one or more hardware processors, first requests made according to the first reservation method prior to a first cut-off time but not after the first cut-off time, the first requests indicating to pick first items. The method can further include, subsequent to the first cut-off time, re-allocating, by the one or more hardware processors, a remaining capacity of the first portion of the vehicle load capacity for one of the plurality of delivery vehicles for filling by the second reservation method rather than the first reservation method. The method can further include optimizing, by the one or more hardware processors, routes for the plurality of delivery vehicles subsequent to the processing the first requests. The method can further include processing, by the one or more hardware processors, second requests made according to the second reservation method prior to a second cut-off time but not after the second cut-off time, the second requests indicating to pick second items. The method can further include re-optimizing, by the one or more hardware processors, the routes for the plurality of delivery vehicles subsequent to the processing the second requests. The re-optimizing the routes for the plurality of delivery vehicles can be performed based on the second requests. The routes for the plurality of delivery vehicles can be re-optimized so that deliveries associated with the second requests are assigned to be made during outward portions of the routes. The processing the first requests can include instructing a plurality of transporting devices to pick the first items from a plurality of stacks of storage containers subsequent to the first cut-off time. The instructing the plurality of transporting devices to pick the first items can include instructing the plurality of transporting devices to pick the first items prior to the second cut-off time. The processing the second requests can include instructing the plurality of transporting devices to pick the second items from the plurality of stacks of storage containers prior to the second cut-off time. The method can further include loading one of the plurality of delivery vehicles with (i) some of the first items based on the allocating the first portion of the vehicle load capacity and (ii) some of the second items based on the allocating the second portion of the vehicle load capacity. The method can further include assigning, by the one or more hardware processors, to one of the plurality of delivery vehicles (i) some of the first items based on the allocating the first portion of the vehicle load capacity and (ii) some of the second items based on the allocating the second portion of the vehicle load capacity. The method can further include loading one of the plurality of delivery vehicles with (i) some of the first items based on the allocating the first portion of the vehicle load capacity and (ii) some of the second items based on the allocating the second portion of the vehicle load capacity and the re-allocating the remaining capacity of the first portion of the vehicle load capacity. The method can further include assigning, by the one or more hardware processors, to one of the plurality of delivery vehicles (i) some of the first items based on the allocating the first portion of the vehicle load capacity and (ii) some of the second items based on the allocating the second portion of the vehicle load capacity and the re-allocating the remaining capacity of the first portion of the vehicle load capacity. The second reservation method can provide a faster delivery for items picked from a warehouse than the first reservation method. The first reservation method can service advanced delivery orders, and the second reservation method can service rapid delivery orders.

According to a further aspect of the present disclosure there is provided a storage system. The storage system can include a first set of parallel tracks, a second set of parallel tracks, a plurality of stacks of storage containers, a transporting device, a picking station, and one or more hardware processors. The first set can extend in an X-direction. The second set can extend in a Y-direction transverse to the first set in a substantially horizontal plane, the first set and the second set forming a grid pattern comprising a plurality of grid spaces. The plurality of stacks of storage containers can be located beneath the first set and the second set and arranged such that each of the plurality of stacks is located within a footprint of a single grid space of the plurality of grid spaces. The transporting device can move on the first set and second set in the X and Y directions above the plurality of stacks and transport a storage container from the plurality of stacks. The picking station can receive the storage container transported by the transporting device and transfer an item from the storage container into a delivery container. The one or more hardware processors can perform the method of any of the preceding two paragraphs. The transporting device can have a footprint that occupies only the single grid space. According to yet another aspect of the present disclosure there is provided non-transitory physical computer storage comprising computer-executable instructions stored thereon that, when executed by one or more hardware processors, are configured to implement a process comprising the method of any of the preceding two paragraphs.

### BRIEF DESCRIPTION OF THE DRAWINGS

The present disclosure will now be described in detail with reference to examples, in which:

FIG. 1 schematically illustrates a storage structure and containers;

FIG. 2 schematically illustrates track on top of the storage structure illustrated in FIG. 1;

FIG. 3 schematically illustrates load-handling devices on top of the storage structure illustrated in FIG. 1;

FIG. 4 schematically illustrates a single load-handling device with container-lifting device in a lowered configuration;

FIG. 5 schematically illustrates cutaway views of a single load-handling device with container-lifting device in a raised and a lowered configuration;

FIG. 6 shows a schematic depiction of a computer device used in the implementation of a method of the present disclosure;

FIG. 7 shows a schematic depiction of a method according to an aspect of the present disclosure;

FIG. 8 shows a schematic depiction of an advanced delivery method; and

FIG. 9 shows a schematic depiction of a rapid delivery method.

### DETAILED DESCRIPTION

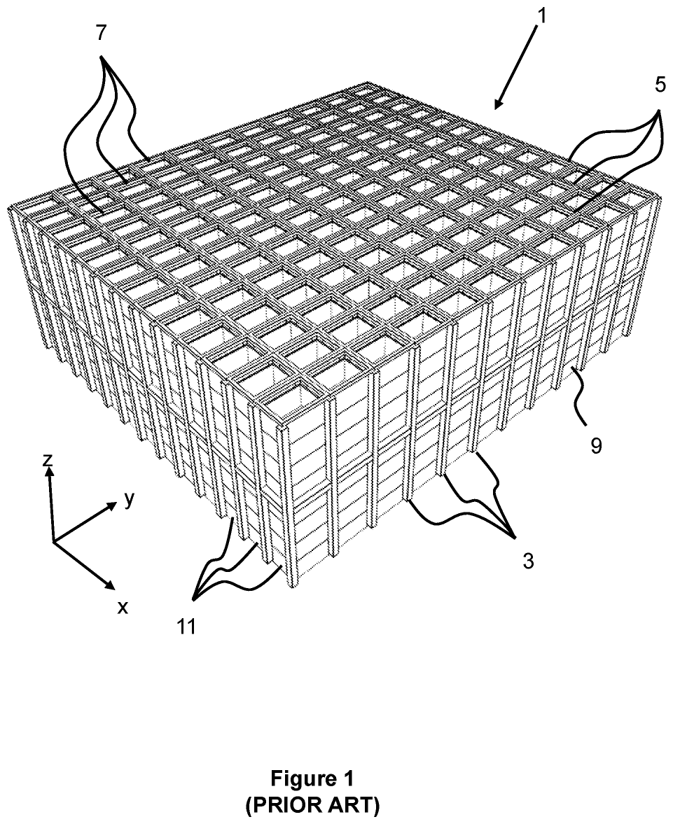

FIG. 1 illustrates a storage structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, containers 9 are arranged in stacks 11 beneath the grid cells defined by the grid pattern, one stack 11 of containers 9 per grid cell.

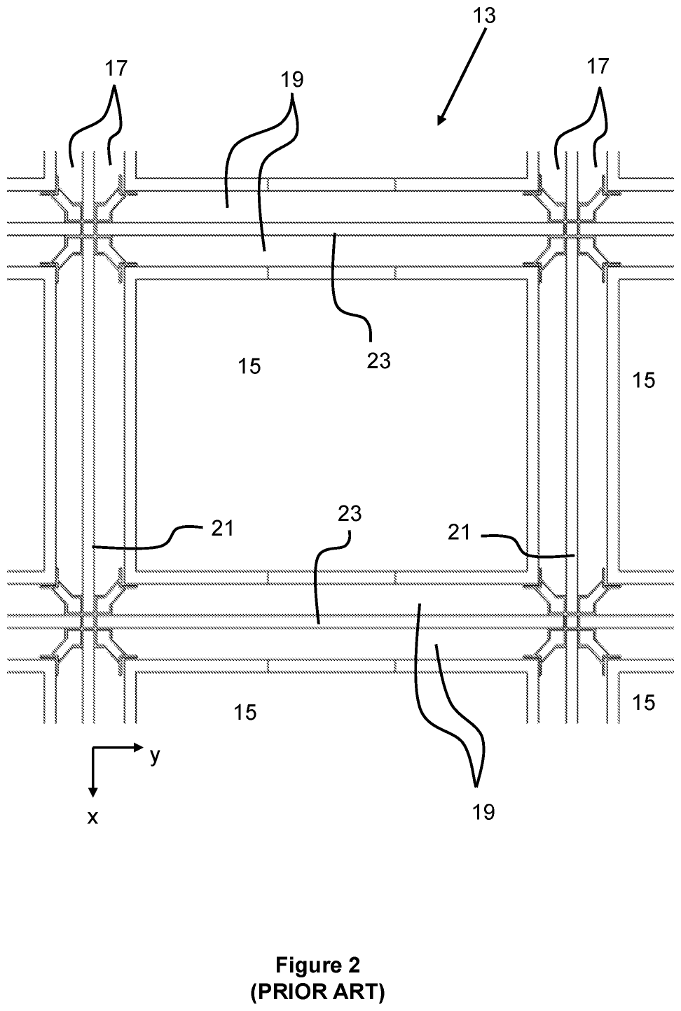

FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

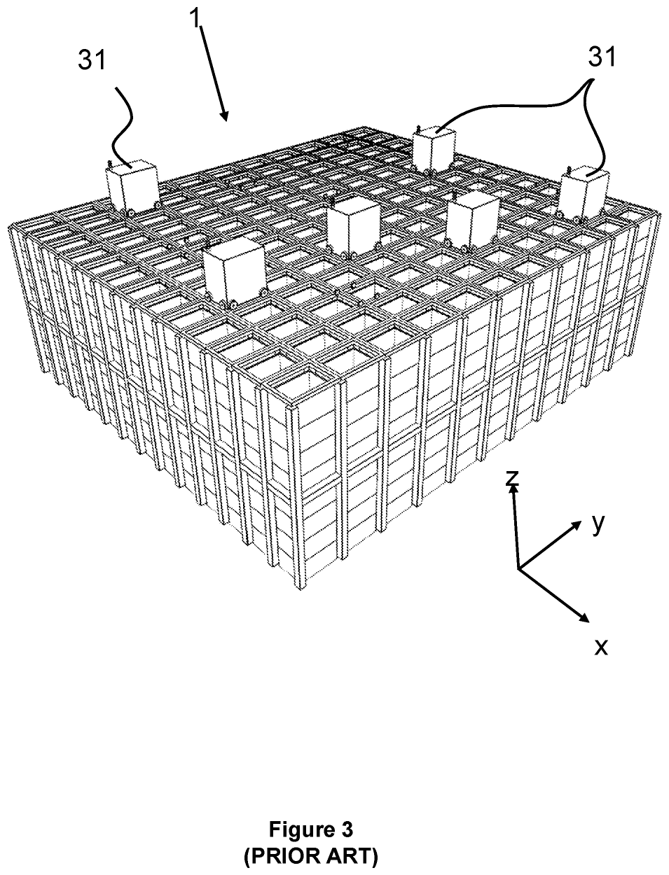

FIG. 3 shows a plurality of load-handling devices 31 moving on top of the storage structure 1 illustrated in FIG. 1. The load-handling devices 31, which may also be referred to as robots 31 or bots 31, are provided with sets of wheels to engage with corresponding x-or y-direction tracks 17, 19 to enable the bots 31 to travel across the track structure 13 and reach specific grid cells. The illustrated pairs of tracks 17, 19 separated by channels 21, 23 allow bots 31 to occupy (or pass one another on) neighbouring grid cells without colliding with one another.

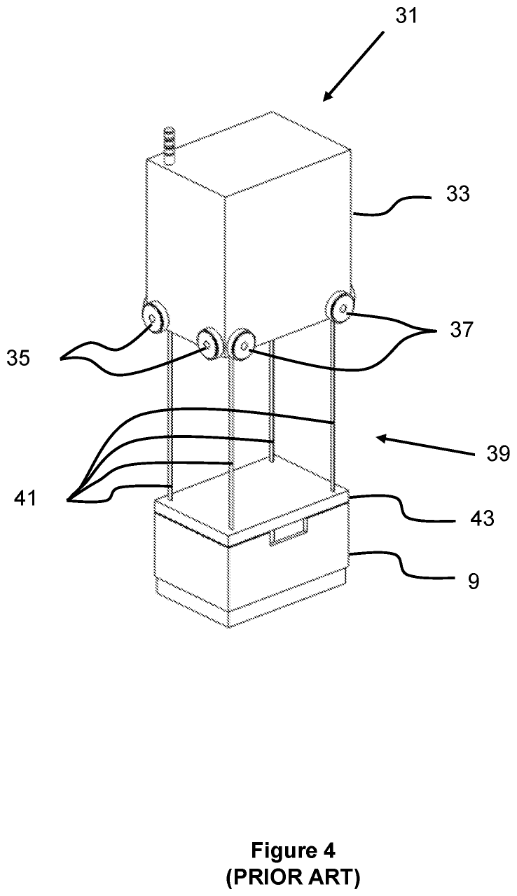

As illustrated in detail in FIG. 4, a bot 31 comprises a body 33 in or on which are mounted one or more components which enable the bot 31 to perform its intended functions. These functions may include moving across the storage structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible in FIG. 4, and a further two wheels 35 are provided on the opposite shorter side of the bot 31 (side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19.

The bot 31 also comprises container-lifting device 39 configured to raise and lower containers 9. The illustrated container-lifting device 39 comprises four tapes or reels 41 which are connected at their lower ends to a container-engaging assembly 43. The container-engaging assembly 43 comprises engaging device (which may, for example, be provided at the corners of the assembly 43, in the vicinity of the tapes 41) configured to engage with features of the containers 9. For instance, the containers 9 may be provided with one or more apertures in their upper sides with which the engaging device can engage. Alternatively or additionally, the engaging device may be configured to hook under the rims or lips of the containers 9, and/or to clamp or grasp the containers 9. The tapes 41 may be wound up or down to raise or lower the container-engaging assembly, as required. One or more motors or other devices may be provided to effect or control the winding up or down of the tapes 41.

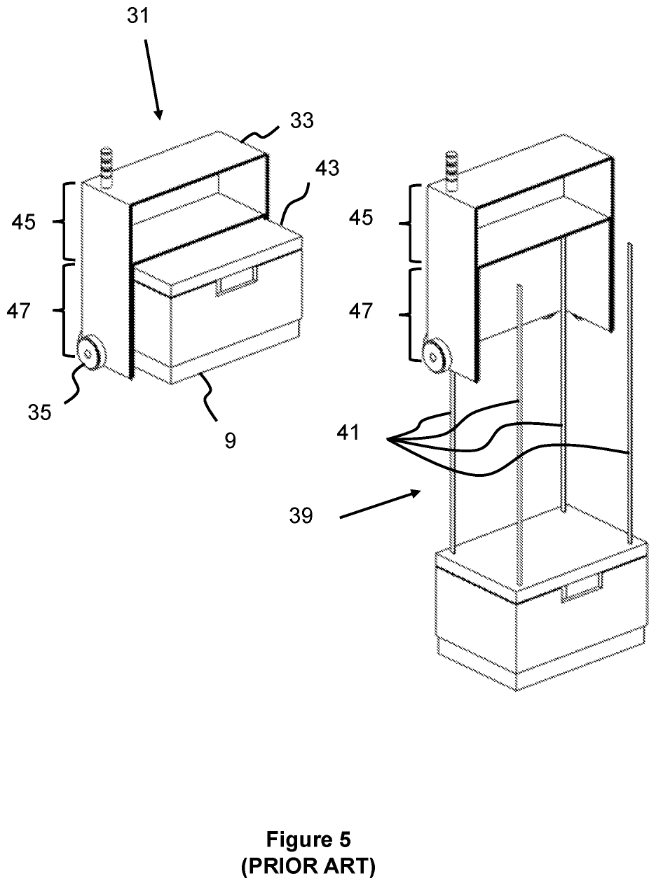

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45. The lower portion 47 comprises a container-receiving space or cavity for accommodating at least part of a container 9 that has been raised by the container-lifting device 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting device 39 controls the tapes 41 to lower the container-gripping assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, the upper and lower portions 45, 47 may not be physically divided by a specific component or part of the body 33 of the bot 31.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other devices for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

To remove a container 9 from the top of a stack 11, the bot 31 is moved as necessary in the X and Y directions so that the container-gripping assembly 43 is positioned above the stack 11. The container-gripping assembly 43 is then lowered vertically in the Z direction to engage with the container 9 on the top of the stack 11. The container-gripping assembly 43 grips the container 9, and is then pulled upwards on the tapes 41, with the container 9 attached. At the top of its vertical travel, the container 9 is accommodated within the vehicle body and is held above the level of the tracks. In this way, the load handling device 30 can be moved to a different position in the X-Y plane, carrying the container 9 along with it, to transport the container 9 to another location. The tapes 41 are long enough to allow the load handling device 30 to retrieve and place containers from any level of a stack 11, including the floor level. The weight of the vehicle may be comprised in part of batteries that are used to power the drive mechanism for the wheels 35, 37.

As shown in FIG. 3, a plurality of load handling devices 31 are provided, so that each bot 31 can operate simultaneously to increase the throughput of the system. The system illustrated in FIG. 3 may include specific locations, known as ports, at which containers 9 can be transferred into or out of the system. An additional conveyor system (not shown) is associated with each port, so that containers 9 transported to a port by a bot 31 can be transferred to another location by the conveyor system, for example to a picking station (not shown). Similarly, containers 9 can be moved by the conveyor system to a port from an external location, for example to a container-filling station (not shown), and transported to a stack 11 by the bots 31 to replenish the stock in the system.

Each bot 31 can lift and move one container 9 at a time. If it is necessary to retrieve a container (“target container”) that is not located on the top of a stack 11, then the overlying containers (“non-target containers”) must first be moved to allow access to the target container. This is achieved in an operation referred to hereafter as “digging”. During a digging operation, one of the bots 31 sequentially lifts each non-target container 9a from the stack 11 containing the target container 9b and places it in a vacant position within another stack 11. The target container 9b can then be accessed by the bot 31 and moved to a port for further transportation.

Each of the bots 31 is under the control of a grid controller. Each individual container 9 in the system is tracked, so that the appropriate containers 9 can be retrieved, transported and replaced as necessary. For example, during a digging operation, the locations of each of the non-target containers is logged, so that the non-target containers can be tracked.

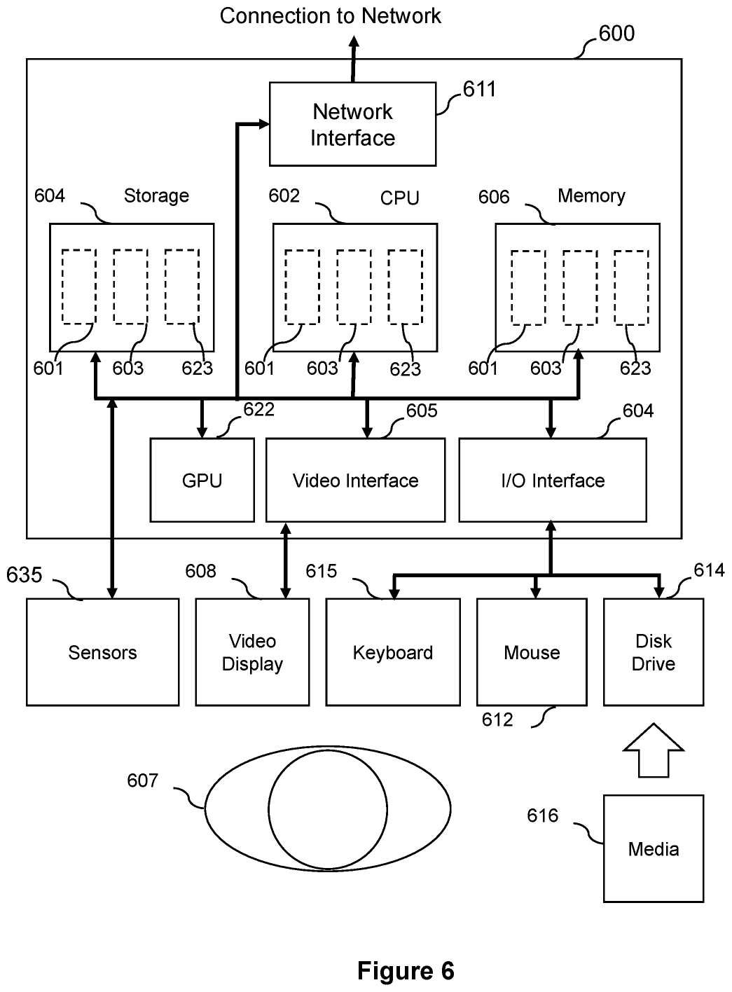

By way of example, FIG. 6 shows a schematic depiction of a computer device 600 used in the implementation of a method of the present disclosure that may include a central processing unit (“CPU”) 602 connected to a storage unit 614 and to a random access memory 606. The CPU 602 may process an operating system 601, application program 603, and data 623. The operating system 601, application program 603, and data 623 may be stored in storage unit 614 and loaded into memory 606, as may be required. Computer device 600 may further include a graphics processing unit (GPU) 622 which is operatively connected to CPU 602 and to memory 606 to offload intensive image processing calculations from CPU 602 and run these calculations in parallel with CPU 602.

An operator 607 may interact with the computer device 600 using a video display 608 connected by a video interface 605, and various input/output devices such as a keyboard 615, mouse 612, and disk drive or solid state drive 614 connected by an I/O interface 604. In a known manner, the mouse 612 may be configured to control movement of a cursor in the video display 608, and to operate various graphical user interface (GUI) controls appearing in the video display 608 with a mouse button. The disk drive or solid state drive 614 may be configured to accept computer readable media 616. The computer device 600 may form part of a network via a network interface 611, allowing the computer device 600 to communicate with other suitably configured data processing systems (not shown). One or more different types of sensors 635 may be used to receive input from various sources.

It should be understood that the control of the storage system may be performed by an appropriately configured industrial computing device, however the features disclosed herein may be implemented using virtually any manner of computer device including a desktop computer, laptop computer, tablet computer, wireless handheld or a cloud computing platform. The computing device or devices may execute one or more software instances, for example virtual machines and or containers. The present system and method may also be implemented as a computer-readable/useable medium that includes computer program code to enable one or more computer devices to implement each of the various process steps in a method in accordance with the present disclosure. In case of more than one computer devices performing the entire operation, the computer devices are networked to distribute the various steps of the operation.

It should be understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system. In further aspects, the disclosure provides systems, devices, methods, and computer programming products, including non-transient machine-readable instruction sets, for use in implementing such methods and enabling the functionality described previously

The system described with reference to FIGS. 1 to 6 has many advantages and is suitable for a wide range of storage and retrieval operations. In particular, it allows very dense storage of product, and it provides a very economical way of storing a huge range of different items in the containers 9, while allowing reasonably economical access to all of the containers 9 when required for picking.

The system described with reference to FIGS. 1 to 6 may be used to fulfil customer order. A customer may place an order which comprises a number of different product items. A customer order may be picked by the retrieval of the appropriate storage containers from the stacks within the storage system and then transferring the storage containers to a picking station. The ordered items can be picked from the storage container and are then transferred to a delivery container. For ease of operation, the delivery container may hold one or more bags or cartons into which the ordered items can be packed. The delivery containers which store all of the items that comprise a customer order may then be routed to a loading point, such that they may be loaded onto a loading frame. The loading frame will hold the delivery containers that comprise a number of different orders. Once all of the delivery containers have been loaded onto the loading frame then the loading frame can be transferred into a delivery vehicle for subsequent onward delivery to a customer.

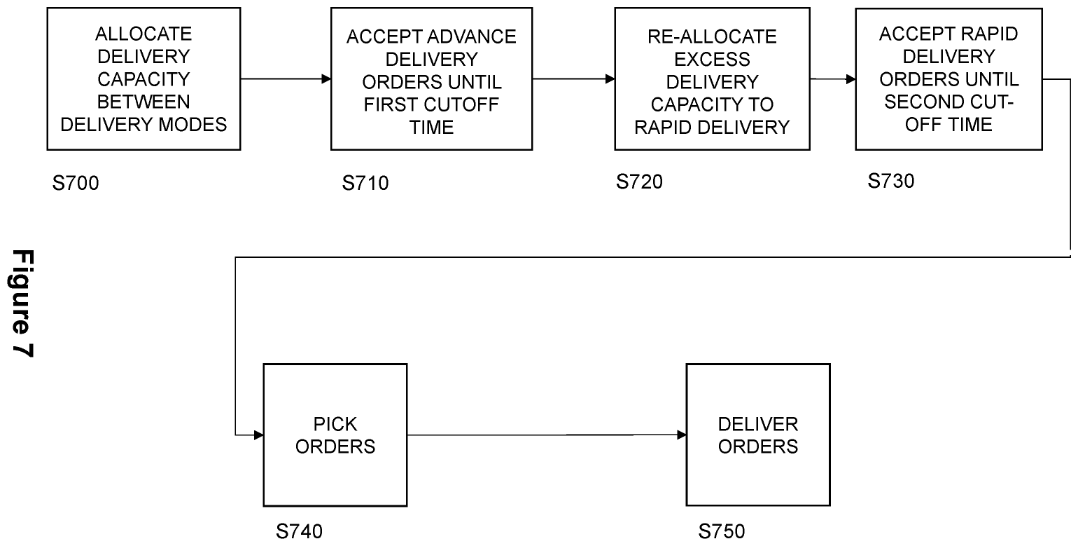

FIG. 7 shows a schematic depiction of a method according to an aspect of the present disclosure. The method uses the automated storage and retrieval system described above with respect to FIGS. 1 to 6. For a given day and for each delivery vehicle a proportion of the delivery vehicle capacity is reserved for use for rapid delivery services and the remainder of the delivery vehicle capacity is allocated for use with advance delivery orders (step S700).

For advance deliveries, a number of timeslots for a given delivery day are made available for customers to book. The timeslots may be made available a number of weeks ahead of the delivery date. As customer orders for advance delivery are received they are assigned to a delivery vehicle that will be able to deliver to the respective customer address within the selected time slot (see below). Customer orders for advance delivery are accepted up until a first cut-off time, that is the cut-off time for advance delivery orders (S710). Typically, this first cut-off time occurs the day before the delivery date (or alternatively a fixed time before the delivery timeslot). Typically, the first-cut off time is the same for all of the delivery vehicles and is advertised to customers so that they have the opportunity to update their order before the time limit.

Once the first cut-off time has passed, any excess delivery capacity which had been allocated for use with advance deliveries is re-allocated such that it can be used for rapid delivery services (step S720). If all of the delivery capacity that had been allocated for use for advance deliveries had been used, then the vehicle capacity that is available for use for rapid deliveries is the capacity that was allocated in step S700.

Rapid delivery orders can be accepted until a second cut-off time (S730). For each of the delivery vehicles it is known how many advance delivery orders have been received, the timeslot and delivery location for each of those delivery orders and the remaining vehicle capacity that can be used for rapid delivery service orders. This information can then be used to offer rapid delivery slots (see below). As rapid delivery orders are accepted then the delivery routes are re-optimised.

Once the second cut-off time is passed then no more rapid delivery service orders will be accepted. The second cut-off time may vary from vehicle to vehicle depending on the planned route and the distance of the customer locations from the fulfilment centre. The second cut-off time may not be advertised to customers but once it is passed then no further delivery slots will be offered for the delivery vehicle(s) in question.

Once the second cut-off time has passed for a delivery vehicle then the delivery route can be optimised for a final time. Each of the orders to be delivered by a delivery vehicle can be picked (S740), loaded into delivery containers and then loaded into the delivery vehicle. The orders can then be delivered to the respective customer locations in accordance with the planned route and delivery timeslots (S750).

The present method allows a single fulfilment centre to deliver goods for both advanced order deliveries and rapid order deliveries. This reduces the need to construct dedicated rapid order delivery fulfilment centres. Furthermore, it enables rapid delivery orders to include products selected from a much wider range of goods, which cannot be achieved using conventional rapid order delivery fulfilment centres.

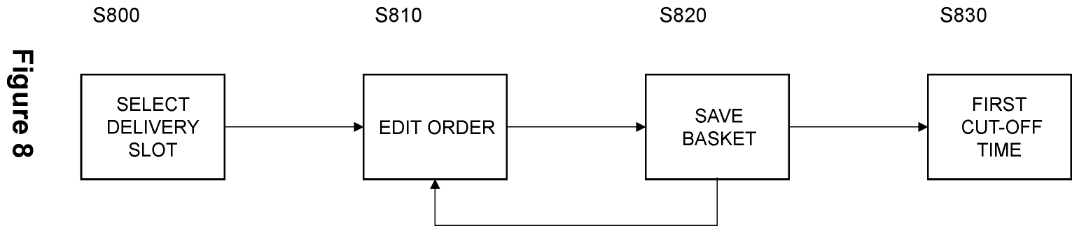

FIG. 8 shows a schematic depiction of an advanced delivery method. At step S800 a customer selects a delivery slot, which is a predetermined timeslot for a given date. Typically a retailer will allow customers to book a slot up to 2 or 3 weeks ahead (although this time period may vary). Once the time slot has been selected then the customer can add their order, adding products that they wish to purchase to their basket (S810). When the customer has finished adding items, they can save their basket (S820); and if they take no further action, then when the first cut-off time is reached (S830), the order is finalised and the customer is not able to make further changes. The customer order may then be picked such that it is ready to be loaded into the respective delivery vehicle when it is time for the vehicle to leave to make the deliveries.

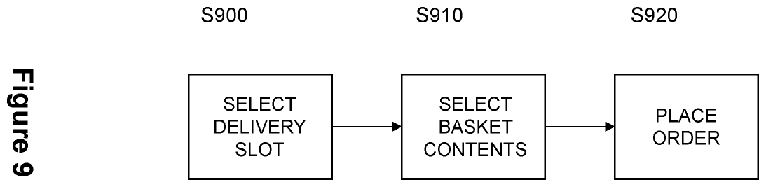

FIG. 9 shows a schematic depiction of a rapid delivery method. At step S900 a customer selects a delivery slot, which is typically for later that day. The location of the customer will be known by the retailer and thus it is possible to determine which delivery vehicles have a delivery route that could be used to serve that customer and also have sufficient delivery capacity for a rapid delivery order. This information can be used to determine the available rapid delivery slots and some or all of these slots can be displayed to the customer such that a selection can be made. If no slots are available then this information can be displayed to the customer. Having selected a rapid delivery slot the customer then selects the desired products (S910) and then places the order (S920). In contrast to the advanced delivery there is no opportunity for the customer to save and then edit their basket of goods.

While it is possible for a rapid delivery order to be picked and then stored within a grid cell of the storage system before then being loaded onto the respective delivery vehicle, this takes more time as the stored picked orders need to be retrieved to be sent for loading. It is preferred that the rapid delivery orders are picked after the second cut-off time, and then loaded into the delivery vehicle. All of the rapid delivery orders to be carried by a single vehicle may be picked in parallel processes and then loaded into the vehicle to reduce the time between the second cut-off time

### Modifications and Variations

It is envisaged that any one or more of the variations described in the foregoing paragraphs may be implemented in the same embodiment of a storage systems.

One of the advantages of a storage and retrieval system as described above with reference to FIGS. 1 to 9 is that the advance delivery orders are known in advance and can be picked and packed into delivery containers in the time between the first cut-off time and the second cut-off time. The advance delivery orders can then be stored within the grid of the storage system until the second cut-off time. For example, if the first cut-off time is 10 pm the day before the delivery date then it is possible for the advanced delivery orders to be picked and stored overnight.

Once the second cut-off time has passed and the rapid delivery orders are being picked then the advance delivery orders can be retrieved from the grid of the storage system such that they can be loaded into the delivery vehicle in parallel with the rapid delivery orders. The operation of the storage system may be configured to minimise the time between the second cut-off time and the time that the delivery vehicle is ready to depart the fulfilment centre.

It is preferred that the rapid delivery orders are performed during the outbound portion of the delivery vehicle route from the fulfilment centre.

When a delivery route is optimised on the basis of a number of advanced delivery orders, one or more dummy route nodes may be added to the delivery route such that the or each dummy node can be subsequently assigned to a rapid delivery order. These dummy routes are preferably added to the outbound portion of the delivery vehicle route.

Optimisation of a vehicle delivery route may comprise moving an order from a first route to a second route or swapping orders between two routes. An advanced delivery order may be moved from a first delivery route to a second delivery route such that a rapid delivery order may be inserted into the first delivery route.

The proportion of the capacity of a delivery vehicle which is allocated to rapid deliveries can be varied in accordance with customer demand. Some customer locations are too far from a fulfilment centre to enable rapid deliveries to be made, in which case the delivery vehicles which are used to deliver to those customer locations may have no vehicle capacity allocated to rapid deliveries.

Although the preceding discussion has been focussed on the delivery of groceries using both advanced and rapid delivery services it should be understood that other goods may be delivered using such delivery services, either in addition to or instead of groceries.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

In this document, “controller” is intended to include any hardware which is suitable for controlling (e.g. providing instructions to) one or more other components. For example, a processor equipped with one or more memories and appropriate software to process data relating to a component or components and send appropriate instructions to the component(s) to enable the component(s) to perform its/their intended function(s).

According to an aspect, the present disclosure provides a storage and retrieval system which can be operated to deliver goods, for example groceries, using two different methods. Capacity within a delivery vehicle may be assigned to orders placed in advance for later delivery and also for rapid orders for quick delivery.

1-20. (canceled)

21. A system comprising:
a first set of parallel tracks extending in an X-direction;
a second set of parallel tracks extending in a Y-direction transverse to the first set in a substantially horizontal plane, the first set and the second set forming a grid pattern comprising a plurality of grid spaces;
a plurality of stacks of storage containers located beneath the first set and the second set and arranged such that each of the plurality of stacks is located within a footprint of a single grid space of the plurality of grid spaces;
a transporting device configured to move on the first set and second set in the X and Y directions above the plurality of stacks and transport a storage container from the plurality of stacks;
a collecting station configured to receive the storage container transported by the transporting device and transfer an item from the storage container into a container; and
one or more hardware processors programmed to:
for each of a plurality of vehicles:
portion a first portion of a vehicle load capacity for filling by a first method; and
portion a second portion of the vehicle load capacity for filling by a second method.

22. The system of claim 21, wherein the transporting device has a footprint that occupies only the single grid space.

23. A method comprising:
for each of a plurality of vehicles:
portioning, by one or more hardware processors, a first portion of a vehicle load capacity for filling by a first method; and
portioning, by the one or more hardware processors, a second portion of the vehicle load capacity for filling by a second method.

24. The method of claim 23, further comprising processing, by the one or more hardware processors, first communications made according to the first method prior to a first cut-off time but not after the first cut-off time, the first communications indicating to collect first items.

25. The method of claim 24, further comprising, subsequent to the first cut-off time, re-portioning, by the one or more hardware processors, a remaining capacity of the first portion of the vehicle load capacity for one of the plurality of vehicles for filling by the second method rather than the first method.

26. The method of claim 24, further comprising optimizing, by the one or more hardware processors, routes for the plurality of vehicles subsequent to the processing the first communications.

27. The method of claim 26, further comprising processing, by the one or more hardware processors, second communications made according to the second method prior to a second cut-off time but not after the second cut-off time, the second communications indicating to collect second items.

28. The method of claim 27, further comprising re-optimizing, by the one or more hardware processors, the routes for the plurality of vehicles subsequent to the processing the second communications.

29. The method of claim 28, wherein the re-optimizing the routes for the plurality of vehicles is performed based on the second communications.

30. The method of claim 29, wherein the routes for the plurality of vehicles are re-optimized so that distributions associated with the second communications are assigned to be made during outward portions of the routes.

31. The method of claim 24, wherein the processing the first communications comprises instructing a plurality of transporting devices to collect the first items from a plurality of stacks of storage containers subsequent to the first cut-off time.

32. The method of claim 31, wherein the instructing the plurality of transporting devices to collect the first items comprises instructing the plurality of transporting devices to collect the first items prior to a second cut-off time, and further comprising processing, by the one or more hardware processors, second communications made according to the second method prior to a second cut-off time but not after the second cut-off time, the second communications indicating to collect second items.

33. The method of claim 32, wherein the processing the second communications comprises instructing the plurality of transporting devices to collect the second items from the plurality of stacks of storage containers prior to the second cut-off time.

34. The method of claim 32, further comprising loading one of the plurality of vehicles with (i) some of the first items based on the portioning the first portion of the vehicle load capacity and (ii) some of the second items based on the portioning the second portion of the vehicle load capacity.

35. The method of claim 32, further comprising portioning, by the one or more hardware processors, to one of the plurality of vehicles (i) some of the first items based on the portioning the first portion of the vehicle load capacity and (ii) some of the second items based on the portioning the second portion of the vehicle load capacity.

36. The method of claim 32, further comprising:
subsequent to the first cut-off time, re-portioning, by the one or more hardware processors, a remaining capacity of the first portion of the vehicle load capacity for one of the plurality of vehicles for filling by the second method rather than the first method; and
loading one of the plurality of vehicles with (i) some of the first items based on the portioning the first portion of the vehicle load capacity and (ii) some of the second items based on the portioning the second portion of the vehicle load capacity and the re-portioning the remaining capacity of the first portion of the vehicle load capacity.

37. The method of claim 32, further comprising:
subsequent to the first cut-off time, re-portioning, by the one or more hardware processors, a remaining capacity of the first portion of the vehicle load capacity for one of the plurality of vehicles for filling by the second method rather than the first method; and
portioning, by the one or more hardware processors, to one of the plurality of vehicles (i) some of the first items based on the portioning the first portion of the vehicle load capacity and (ii) some of the second items based on the portioning the second portion of the vehicle load capacity and the re-portioning the remaining capacity of the first portion of the vehicle load capacity.

38. The method of claim 23, wherein the second method provides a faster distribution for items collected from a building than the first method.

39. The method of claim 23, wherein the first method handles first communications, and the second method handles second communications.

40. Non-transitory physical computer storage comprising computer-executable instructions stored thereon that, when executed by one or more hardware processors, are configured to implement a process comprising the method of claim 23.
